(19) United States
(12) Patent Application Publication
(10) Pub. No.: US 2007/0128423 A1
(43) Pub. Date: Jun. 7, 2007

(54) Imprinting a substrate for separation of a target molecule from a fluid medium

(76) Inventors: Georges J. Belfort, Slingerlands, NY (US); Mina Han, Seoul (KR); Ravindra S. Kane, Niskayuna, NY (US)

Correspondence Address: Michael L Goldman;Nixon Peabody, Clinton Square, PO Box 31051, Rochester, NY, 14603, US

(21) Appl. No.: 10/524,509

(22) PCT Filed: Aug. 13, 2003
(86) PCT No.: PCT/US03/25248

§ 371 Date: Jan. 11, 2006

Related U.S. Application Data
(60) Provisional application No. 60/403,530, filed on Aug. 14, 2002.
(60) Provisional application No. 60/462,356, filed on Apr. 11, 2003.

(51) Int. Cl. C08F 2/46; B05D 3/02; B32B 3/26

(52) U.S. Cl. 428/304.4; 427/384; 427/487

(57) ABSTRACT

The present invention is directed to a method of producing a substrate suitable for separation of a target molecule from a fluid medium. This method includes providing an emulsion comprising a water phase in an oil phase, where the oil phase contains a polymerizable monomer and the water phase contains the target molecule. The substrate, having pores extending from one side of the substrate to another side of the substrate, is coated with the emulsion, and the monomer in the emulsion coated substrate is then polymerized. The water and target molecule are removed from the polymerized, emulsion coated substrate. As a result, the substrate is imprinted with the target molecule and, therefore, is suitable for separation of the target molecule from a fluid medium. The resulting article and its use are also disclosed.

This application claims benefit of U.S. Provisional Patent Application Ser. Nos. 60/403,530, filed Aug. 14, 2002, and 60/462,356, filed Apr. 11, 2003.

### FIELD OF THE INVENTION

The present invention relates to a method of producing a substrate suitable for separating a target molecule from a fluid medium, an article containing that substrate, and method of using that article to separate a target molecule from a fluid medium.

### BACKGROUND OF THE INVENTION

The concept of molecular imprinting is depicted in FIG. 1 (Haupt et al., Trends in Biotechnol (1998)). The molecule to be imprinted is first allowed to form bonds with polymerizable functional groups, which are then crosslinked. Following extraction of the print or template molecule, specific recognition sites are left in the polymer where the spatial arrangement of the polymer network and the immobilized functional groups correspond to the geometry and chemistry of the imprinted molecule.

Molecular imprinting had its origins in the work of Linus Pauling in the 1940's (Pauling, J. Am. Chem Soc. 62:2643 (1940)) in which he speculated on how the body generates its seemingly endless diversity of antibodies. He theorized that the body sends out an array of building blocks that mold themselves around the antigen molecule and thus “imprint” it. While this theory of antibody generation was incorrect, it was the seed idea of generating imprints of a molecule. The imprinting of organic polymers was first reported by Wulff et al., Angew. Chem. 84:364 (1972). This approach was based on covalently bonding the template or print molecule to the monomers. However, in the early 1980's, Mosbach et al. succeeded in demonstrating molecular imprinting for non-covalently linked templates (Arshady et al., Makromol. Chem., 182:687 (1981)).

The covalent approach (FIG. 1 (right hand process scheme)) requires a polymerizable derivative of the imprint species that is subsequently incorporated into the polymer matrix during polymerization. These covalent bonds must be cleavable. The most common linkages are esters or imines. The need for such derivatives constrain the versatility of the approach and reduce the number of the species that can be imprinted. After the polymer is formed, the imprint species is extracted by cleavage of these bonds usually by acid hydrolysis. Rebinding of the imprint species to the matrix is then achieved by reestablishing the covalent bonds between the print molecule and the matrix.

The non-covalent (FIG. 1 (left hand process scheme)) approach exclusively uses non-covalent interactions in the recognition of the imprint species. The greater the variety of interactions available between the imprint species and the functional monomers, the better the artificial binding site becomes. Typical interactions that are exploited include ionic, metal-chelate, H-bonding, π-π, and hydrophobic interactions. Since these are strongly dependent on the polarity of the solvent, the best imprints are made in organic solvents such as chloroform and toluene. When these weak interactions between the functional groups and the template molecule are established in solution through self-assembly, polymerization is initiated, using a crosslinker in the presence of a porogen. As a result, a molecular matrix is formed around the template in three dimensions. The template can then be removed by mild extraction from the matrix.

Four main areas of applications have been investigated (see reviews by Mosbach et al., Bio/Technology 14:163 (1996) and Wulff, Angewandte Chemie lnt. Ed. Engl. 34:1812 (1995)). These include the use of molecularly imprinted polymers (“MIPs”) as: (i) tailor made separation materials, (ii) as antibody and receptor mimics in recognition and assay systems, (iii) for catalytic applications as enzyme mimics, and (iv) as recognition elements in biosensors.

With regard to separations, MIPs can be used as separation materials with tailor made selectivity. The high binding specificity for the template molecule has been used for chiral separations using molecularly imprinted chromatographic stationary phases (Kempe et al., J. Chrom. 694:3 (1995)). Examples of molecules that have been separated include naproxen (nonsteroidal anti-inflammatory drug) (Kempe et al., J. Chrom. 664:27 (1994)) and timolol (β-adrenergic blocker) (Fischer et al., J. Am. Chem. Soc. 113:9358 (1991)). Good selectivities ˜18 have been obtained for the separation of enantiomers of the dipeptide N-acetyl-Trp-Phe-OMe (Ramstrom et al., Tetrahedron: Asymmetry 5:849 (1994)). Although the dominant application of MIP has been in column chromatography, other separation systems such as thin layer chromatography (Kriz et al., Anal Chem. 88:263 (1994)) and capillary electrophoresis (Nilsson et al., J. Chrom. 680:57 (1994)) have also been examined. Recently, several applications of molecularly imprinted membranes have been investigated (Yoshikawa et al., J. Memb. Sd. 108:171 (1995); Yoshikawa et al., Macromolecules 29:8197 (1996); and Wang et al., Langmuir 12:485 (1996)).

MIPs have been prepared in various ways depending on the end use of the polymer. While in situ polymerization has been carried out for monolithic chromatographic stationary phases (Svec et al., Anal. Chem. 64:820 (1992)) and for capillary electrophoresis (Nilsson et al., J. Chrom. 680:57 (1994)), the most common technique has been the preparation of chromatographic beads (most often by grinding the molecularly imprinted polymer). Several techniques have been used for the preparation of chromatographic particles including: (i) grafting/coating of the polymer to silica or trimethylolpropane trimethacrylate particles (Dahl et al., Chem. Mat 1:154 (1995)), and (ii) preparation of beads by suspension, emulsion (Sellergren, Chromatogr. 673:133 (1994)) or aerosol (Vorderbruggen et al., Chem. Mat. 8:1106 (1996)) polymerization.

The single most widely used functional monomer is methacrylic acid (“MAA”) which likely binds via ionic interactions with amines and via hydrogen bonds with amides, carbamates, and carboxyls (Kempe et al., J. Chrom. 694:3 (1995)). Ionic interactions are much stronger than H-bonds. Thus, higher selectivities are expected with polymers imprinted with the templates containing ionic bonds as opposed to H-bonds. For templates having both hydrogen bonding and acidic functional groups, the combination of methacrylic acid and a basic functional monomer (vinylpyridine) has been shown to give MIPs with improved enantioselectivity (Yu et al., J. Org. Chem. 62:4057 (1997)). One problem with this combination is the possibility of forming H-bonds between the two functional monomers. If acrylamide is used instead of acrylic acid this problem can be solved.

The four most commonly used polymer systems are (Mosbach et al., Bio/Technology 14:163 (1996)): (i) Polyacrylate/acrylamide-based systems with ethylene dimethacrylate (“EDMA”) as the crosslinker (typical functional monomers are carboxylic acids (e.g., acrylic acid, methacrylic acid) or sulfonic acids (e.g., acrylamido methylpropane sulfonic acid)); (ii) Polystyrene-based systems with functional monomers such as vinylbenzoic acid and vinylpyridine; (iii) Polysiloxane-based systems; and (iv) Iminodiacetic acid derivatives for metal chelate interactions. A list of some of the commonly employed functional monomers and cross-linkers have been summarized by Kempe et al., J. Chrom. 694:3 (1995).

Organic solvents are extensively used in preparing imprinted polymer systems. Because of the desire to minimize the use of toxic organic solvents, solvent-free and aqueous systems are being sought. The proposed research will be conducted in aqueous solutions or suspensions.

While numerous reports of molecular imprints of small molecules exist in the literature, very few successful attempts seem to have been made to imprint proteins. As has been pointed out earlier (Haupt et al., Trends in Biotechnol (1998)), the limitations are related to the labile and flexible nature of proteins thus making polymerization in their presence difficult.

Recently, several proteins have been copolymerized in acrylamide with N, N, N′, N′-tetramethyl (“TEMED”) as the crosslinker to produce protein imprinted stationary phases (Hjerten et al., Chromatog 44:227 (1997)). They obtained selectivity for growth hormone over human serum albumin (“HSA”) and for horse myoglobin over whale myoglobin. While these authors have been unable to confirm complete removal of the templating protein from their stationary phase, these selectivities between closely related proteins show some promise for the future.

In recognition of the fact that stronger interactions between the template and the polymer results in greater selectivity, metal chelate interactions have been proposed for use in imprinting proteins (Dahl et al., J. Am. Chem. Soc. 113:7413 (1991); Dahl et al., Macromoelcules 25:7051 (1992); Mallik et al., New J Chem 18:29 (1993); Mallick et al., J. Am. Chem. Soc. 116:8902 (1994); Sun et al., Org. Lett. 2:911-15 (2000); Roy et al., J. Chem. Soc. Chem. Commun. 547-48 (2000); and Roy et al., J. Org. Chem. 64:2969-74 (1999)). The authors visualize a 3D array of metal ions which are arranged in the precise locations where the interacting amino acids (His, Trp, and Phe) are present on the protein surface. This approach has been demonstrated for several “protein analogs” which are small molecules with imidazole rings spaced at varying intervals. Since proteins are bulky molecules, the use of surface imprinting employing self-assembled monolayers has also been proposed for protein imprinting (Mallick et al., J. Am. Chem. Soc. 116:8902 (1994)).

Another interesting area of investigation has been the imprinting of proteins themselves (Dabulis et al., Biotechnol. Bioeng. 39:176 (1992)). The authors lyophilized bovine serum albumin (“BSA”) in the presence of L-malic acid and observed that this led to a protein preparation that was selective for L-malic acid in organic media. However, the selectivity was lost in aqueous environments. This demonstrated that proteins behave similar to other polymers and can retain a “memory” of the environment in which they were prepared. A protocol for the surface template imprinting of proteins is shown in FIG. 2. Although this approach by Shi et al., Nature 387:593 (1999) is elegant and the separation factors for protein recovery from binary mixtures are reasonably high, the method is complicated and “backwards”—i.e. the flat mica surface on which the protein is originally placed needs to be peeled away to expose the imprinted cavity. Adapting this technology from a flat surface with low surface area to a geometry with high surface area (i.e. porous beads or membranes) will be difficult.

As mentioned above, large imprint molecules, such as proteins, offer difficulties for traditional polymer imprinting methods, because they are labile and flexible making the formation of a stable rigid structure troublesome. Several approaches have been pursued to overcome these difficulties including surface imprinting. Arnold and her group have used stronger functional interactions than electrostatic and hydrogen bonding to immobilize a part of the molecule (Dahl et al., J. Am. Chem. Soc. 113:7413 (1991); Dahl et al., Macromoelcules 25:7051 (1992); Mallik et al., New J. Chem 18:29 (1993); Mallik et al., J. Am. Chem. Soc. 115:2518 (1993); Mallick et al., J. Am. Cizem. Soc. 116:8902 (1994)). Kempe et al., J. Chrom. 694:3 (1995) imprinted the enzyme ribonuclease A on the surface of a silica particle using a polymerizable metal chelate as the functional monomer. Surface imprinting has also been used to immobilize and select for inorganic ions such as calcium and magnesium. One method used the neutral ionophore complexing agent N,N′-dimethyl-N,N′-bis(4-vinyl phenyl)-3-oxapentanediamide for calcium (Rosatzin et al., Chem. Soc. Perkin Trans. 2:1261 (1991)), while another approach has used a polymerizable water-in-oil emulsion with surfactant functional molecules such as dioleyl phosphoric acid (Uezu et al., J. Chem. Engr. Japan 27:436 (1994)). To reduce swelling and render the polymer rigid, they post-treat the surface imprinted polymer with γ-radiation. Large separation factors close to 20 were reported for Zn (II) over Cu (II). The method facilitates the use of water-soluble substances and has fast rebinding kinetics (Uezu et al., Chemtec 29:12 (1999)). They have also used the technique to produce an artificial biocatalyst (Yoshida et al., Macromolec. 32:1237 (1999)).

The use of molecularly imprinted membranes for separations has the singular advantage of speed. The main reason for this is that transport for chromatographic beads is limited by diffusion, while for membranes, convection dominates transport and diffusion plays a minor role. This problem, slow diffusion, is exacerbated with large biological molecules, such as peptides and proteins.

Two of the chief problems in producing molecularly imprinted membranes have been the rigid gel type matrices and the low capacity of imprinted sites commonly employed for molecular imprinting. These matrices are unsuitable for producing membranes due to their low porosities and resulting lower fluxes. Since the surface area within the porous matrix of membranes is usually less than that for beads, it is essential that a high density of imprinted cavities be present in membranes.

Several different approaches have been used to prepare molecular imprinted membranes against small organic molecules and are summarized in Table 1.

TABLE 1
Summary of Molecular Imprinting for Synthetic Membranes

| | Method | | | | Separation | |
|---|---|---|---|---|---|---|
| | Functional | | | | factor | |
| Function | group | Preparation | Separation | Test mode | α | Reference |
| Enantio- | Amino acid (AA) | Add AA to casting | L-Phe from D-Phe | Ultra-filtration | 1.25-4.1 | Masawaki et al., |
| selective | | solution | | | | 1992^{a} |
| Enantio- | Tetra-peptide (TP) | Add TP to casting | L-Trp from D-Trp | Diffusion | 1.4 | Yoshikawa |
| selective | | solution | | | | et al., 1995^{b} |
| | Tetra-peptide | Add TP to casting | L-Trp from D-Trp | Electro-dialysis | 6.0 | Yoshikawa |
| | | solution | | | | et al., 1996^{c} |
| | Tetra-peptide | Add ATP to casting | L-Trp from D-Trp | Electro-dialysis | 1.3 | Yoshikawa |
| | | solution | | | | et al., 1997^{d} |
| Affinity | Acrylic acid (Aa) | Phase inversion | Theophylline | Ultra-filtration | 9.5 | Wang et al. |
| fractionation | | | from caffeine | | | 1996^{c} |
| | Acrylic acid (Aa) | Photograft | Theophylline | Ultra-filtration | 5.9 | Kobayashi et al., |
| | | | from caffeine | | | 1997^{f} |
| Affinity | 9-ethyl adenine | Cast | Adenosine from | Diffusion | 3.4 | Mathew-Krotz et |
| fractionation | | | guanosine | | | al., 1996^{g} |
| Affinity | 2-acrilamido-2- | Photo-grafting | Desmetryn from | Micro-filtration | 1.7 | Piletsky et al., |
| fractionation | methyl-propane | | s-triazines | | | 1999^{h} |
| | sulfonic acid | | | | | |

^{a}Masawaki et al., J. Chem. Engr. Japan 25(1): 33 (1992)
^{b}Yoshikawa et al., J. Memb. Sd. 108: 171 (1995)
^{c}Yoshikawa et al., Macromolecules 29: 8197 (1996)
^{d}Yoshikawa et al., Polymer J. 29(3): 203 (1997)
^{e}Wang et al., Langmuir 12: 485 (1996)
^{f}Kobayashi et al., Chem. Lett. 10: 927-28 (1995)
^{g}Mathew-Krotz et al., J. Am. Chem. Soc. 118: 8154-8155 (1996)
^{h}Piletsky et al., Macromolecules, submitted (1999)

For three cases, the separation factor was greater than 5.0. Yoshikawa's group added a tetrapeptide to the casting solution and, then, after precipitation and gelation, used electrodialysis to separate L-trp from D-trp (Yoshikawa et al., Macromolecules 29:8197 (1996)). The permeation rates were, however, low. The most encouraging results were obtained by Kobayashi et al., (Wang et al., Langmuir 12:485 (1996) and Kobayashi et al., Chem. Lett. 10:927-28 (1995)). They tested two different methods of preparing imprinted porous membranes. In the phase inversion process, they covalently attached an acrylic acid group to acrylonitrile, a well-known membrane-forming monomer, and cast the membrane in the presence of solvents, a crosslinker, a porogen, and the imprint molecule (i.e. theophylline) (Wang et al., Langmuir 12:485 (1996)). The resultant membrane with carboxylic acid functional groups assembling around the imprint molecule showed high selectivity (=9.5) but low volume fluxes (5.3×10⁻⁵ cm/s). In another paper, they deposited a gel layer, containing theophylline, acrylic acid as a functional group and a cross-linker, N,N′-methylenebisacrylamide (“MBAA”), onto a specially prepared photoactive polymeric ultrafiltration membrane (poly(acrylonitrile-co-diethylaminodithiocarbamoylmethylstryrene), (“PAN”-co-“DTCS”)) (Kobayashi et al., Chem. Lett. 10:927-28 (1995))(FIG. 3). The resultant gel on the membrane containing carboxylic acid functional groups assembled around the imprint molecule showed fairly high selectivity (=5.9) but low volume fluxes (9.5×10⁻⁵ cm/s). The main complication here was the need to prepare a special photo-active membrane surface so that photo-oxidation and radical polymerization could be used to form the imprinted gel layer. The membrane also contained unwanted finger-like macrovoids.

The present invention is directed to overcoming the above-noted deficiencies in the art.

### SUMMARY OF THE INVENTION

The present invention is directed to a method of producing a substrate suitable for separation of a target molecule from a fluid medium. This method includes providing an emulsion comprising a water phase in an oil phase, where the oil phase contains a polymerizable monomer and the water phase contains the target molecule. The substrate, having pores extending from one side of the substrate to another side of the substrate, is coated with the emulsion, and the monomer in the emulsion coated substrate is then polymerized. The water and target molecule are removed from the polymerized, emulsion coated substrate. As a result, the substrate is imprinted with the target molecule and, therefore, is suitable for separation of the target molecule from a fluid medium.

Another aspect of the present invention is directed to an article suitable for separation of a target molecule from a fluid medium. The article includes a substrate, having pores extending from one side of the substrate to another side of the substrate, and a coating over the substrate. The coating is imprinted with cavities having a conformation substantially corresponding to the target molecule. The coating comprises a functional group extending into the cavity which is suitable to bind to the target molecule.

A further aspect of the present invention is directed to a method of separating a target molecule from a fluid. This method involves providing the article of the present invention and contacting a fluid potentially containing the target molecule with the article under conditions effective to remove the target molecule from the fluid.

The present invention involves an advance from the approach of Uezu et al., Chemtec 29:12 (1999), which is hereby incorporated by reference in its entirety, by significantly simplifying their process and converting it to a surface format by depositing an emulsion gel onto a commercial microporous poly(ether sulfone) (“PES”) membrane. Instead of preparing a special photo-active membrane support layer, the present invention utilizes commercial poly(ether sulfone) (“PES”) ultra- and microfiltration membranes that are already photo-active and do not have macrovoids (Yamagishi et al., J. Mem. Sci. 105:249 (1995), which is hereby incorporated by reference in its entirety). p While the advantage of molecular imprinting as a process for creating highly selective recognition and binding sites is clear, the following issues need to be addressed in order for this technology to become commercially viable: the need for substantial amounts of the print molecule; low capacity; heterogeneity of the binding sites; mass transfer limitations; restriction of traditional molecularly imprinted polymers to imprinting small molecules; and the need for organic solvents.

The present invention overcomes these deficiencies. The need for substantial amounts of the print molecule can be somewhat alleviated by the number of cycles an MIP can be reused before loss of selectivity (Haupt et al., Trends in Biotechnol (1998), which is hereby incorporated by reference in its entirety). The low capacity of the current molecularly imprinted polymers employed (Wulff, Angewandte Chemie Int. Ed. EngI. 34:1812 (1995), which is hereby incorporated by reference in its entirety) (i.e. only ˜90% of the templates incorporated in the polymer can be removed and only ˜80% of the sites left behind can be reoccupied for covalent molecular imprinting and only ˜10-15% of the sites can be reoccupied for non-covalent molecular imprinting) is obviated by using surface imprinting, because less template molecules are needed and the efficiency for removal and reoccupation is far higher than the above numbers. The heterogeneity of the binding sites is a common feature of MIP (Mosbach et al., Bio/Technology 14:163 (1996), which is hereby incorporated by reference in its entirety), because of different modes of interactions of the template molecule with the polymer in different sites and swelling of these sites. Also, when the beads or substrates are prepared by crushing the solid to expose the active sites, different geometric cavities are exposed, resulting in different interactions and loss of sensitivity. Site heterogeneity leads to peak tailing in chiral separations and polyclonality and loss of specificity in the case of artificial antibodies. In fact, all separations on molecularly imprinted polymers show a significant increase in the tailing of the peak of the imprint molecule. Mass transfer limitations are alleviated by the use in surface imprinting of well-characterized and stable commercial membranes and convective flow in membrane imprinted pores which is significantly faster than diffusion in molecularly imprinted polymer beads. Surface imprinting can alleviate any restriction to imprinting small molecules, environmental concerns, and the inability to imprint biological molecules in organic media by use of aqueous solutions.

Thus, surface imprinting on synthetic commercial membranes addresses these limitations by requiring less imprint molecules (as none is needed in the polymer interior), increasing site capacity, access and speed of the imprint molecules for the imprint sites, reduce tailing with increased mass transfer, and allowing imprinting with larger molecules of biological interest in aqueous environnents.

### BRIEF DESCRIPTION OF THE DRAWINGS

FIG. 1 is a schematic drawing showing a process for molecular imprinting (Haupt et al., Trends in Biotechnol (1998)).

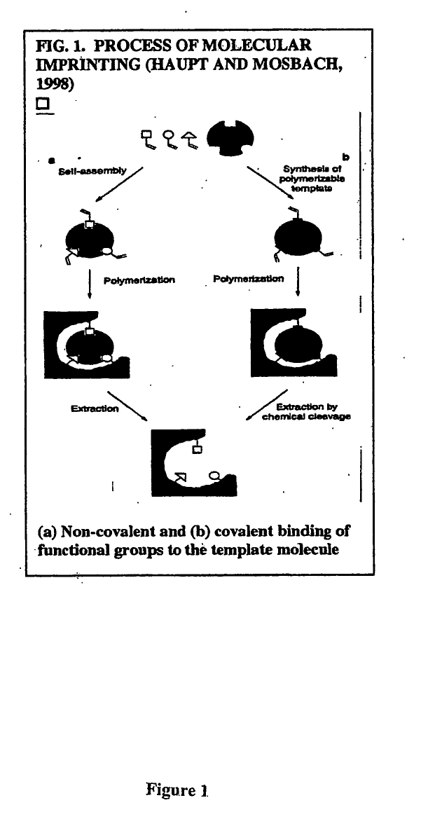

FIG. 2 is a schematic drawing showing the molecular imprinting on a flat surface (Shi et al., Nature 387:593 (1999)). As shown in this figure, a cavity is formed by placing the protein on smooth mica, covering it with polysaccharides, then cross-linking a polymeric film, peeling off the mica, and extracting the protein.

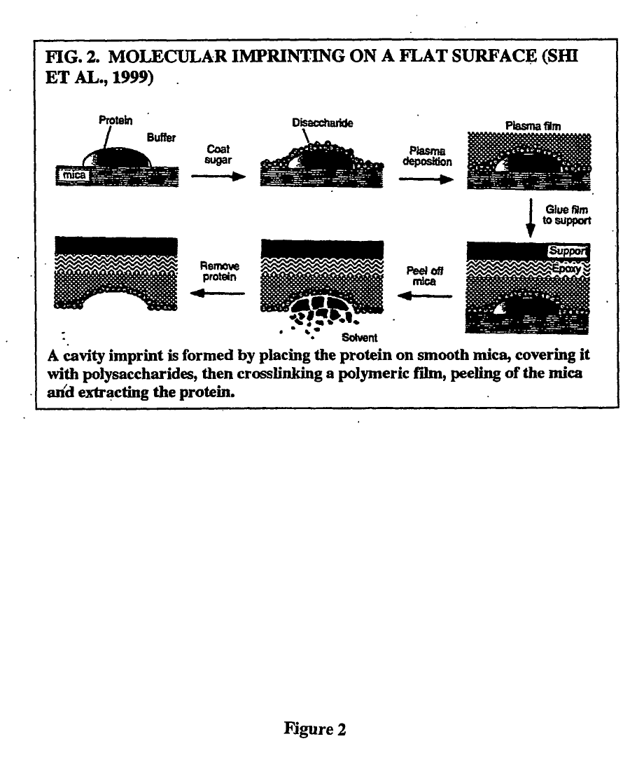

FIG. 3 is a schematic drawing showing the surface imprinting with photooxidation (Kobayashi et al., Chem. Lett. 10:927-28 (1995)). As shown in this figure, the photoactive group (e.g., DTCS) is chemically attached to the PAN prior to casting and activated with Uv irradiation in the presence of the initiator, cross-linker, the functional group, and template (e.g., theophylline (“THO”)).

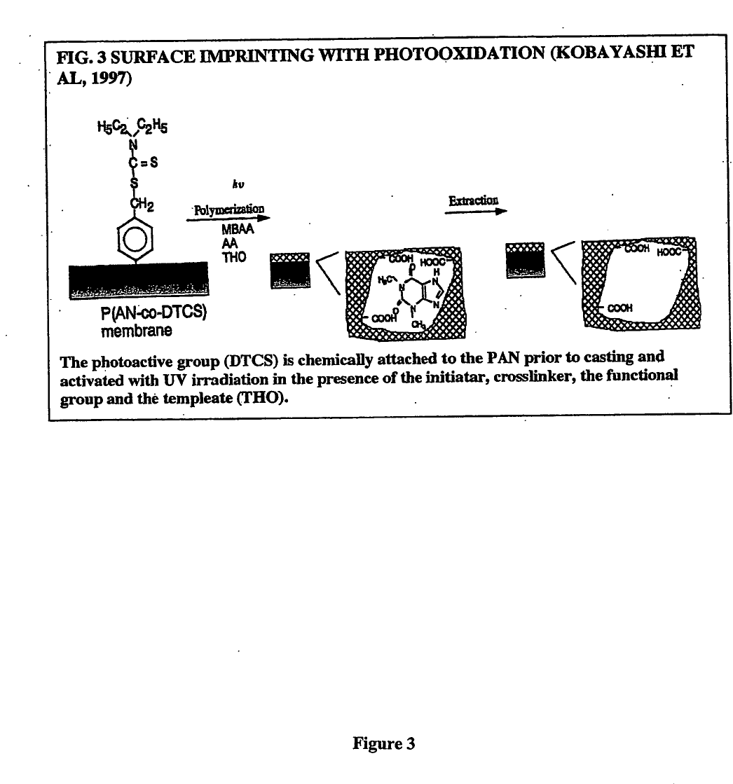

FIG. 4 is a schematic drawing showing the surface template photooxidation process of the present invention. As shown in this figure, poly(ether sulfone) (“PES”) is irradiated in the presence of a template (e.g., THO), crosslinker (e.g., N,N¹-methylene bisacrylamide (“MBA”)), and a functional group (e.g., 2-acriloamido-2-methyl-propane sulfonic acid (“AMS”)). Microwaves are used to extract the water and template selectively.

FIG. 5 is a schematic drawing showing the surface emulsion polymerization with photooxidation. As shown in this figure, after casting the water-in-oil emulsion on a surface, the oil phase is solidified by UV irradiation and the water phase containing the template is extracted leaving in imprinted pit.

FIGS. 6A-H show the chemical structure of the materials used for imprinting THO on a microporous polypropylene membrane using a water-in-oil emulsion photo-polymerization method.

FIG. 7 is a schematic representation of a novel two-dimensional method for surface imprinting recognition sites onto a microporous substrate (Celgard®2500 microporous flat sheet polypropylene membrane) using water-in-oil emulsion photoinduced polymerization.

FIG. 8 shows an attenuated total reflection Fourier transform infrared (“ATR/FT-IR”) spectra of (a) unmodified polypropylene membrane, (b) THO-imprinted polypropylene membrane, and (c) after dipping the imprinted membrane into 1 mM THO solution for 1 day.

FIGS. 9A-C show topographical atomic force microscope (“AFM”) images of the unmodified polypropylene membrane (FIG. 9A), the THO-imprinted polypropylene membrane (without template present) (FIG. 9C), and the THO-imprinted polypropylene membrane with THO in the recognition sites (after dipping the imprinted membrane into 1 mM THO solution for 1 day) (FIG. 9C). Average roughness, Rₐᵥₑ, for a 3×3 μm² area of FIGS. 9A-C was 232±40 Å, 220±20 Å, and 330±50 Å, respectively (Table 1).

FIG. 10A shows competitive THO binding to the imprinted (filled circle) and to the nonimprinted (open square) polypropylene membrane as a fimction of the concentration of THO and caffeine (“CAF”) (1:1) in a water:ethanol =1:1 (v/v)) solution. FIG. 10B shows competition of THO binding to the imprinted polypropylene membrane as measured by [THO]ₛ^{t}/[CAF]ₛ^{t} remaining in solution (filled circle) is a function of the number of imprinted polypropylene membranes (i.e. number of recognition sites) dipped into 0.2 mM THO and CAF (1: 1) in a water:ethanol (1:1 (v/v)) solution). The separation factor (open square), calculated according to Eq. (2) in the text, is also plotted against number of imprinted membranes. Inserts: NMR spectra (ranging from 3.7-3.4 ppm) of initial 0.2 mM THO and CAF (1:1) solution (left) and of remaining solution after dipping 5 sheets of imprinted membrane into 0.2 mM THO and CAF (1:1) solution for 1 day (right).

### DETAILED DESCRIPTION OF THE INVENTION

The present invention is directed to a method of producing a substrate suitable for separation of a target molecule from a fluid medium. This method includes providing an emulsion comprising a water phase in an oil phase, where the oil phase contains a polymerizable monomer and the water phase contains the target molecule. The substrate, having pores extending from one side of the substrate to another side of the substrate, is coated with the emulsion, and the monomer in the emulsion coated substrate is then polymerized. The water and target molecule are removed from the polymerized, emulsion coated substrate. As a result, the substrate is imprinted with the target molecule and, therefore, is suitable for separation of the target molecule from a fluid medium.

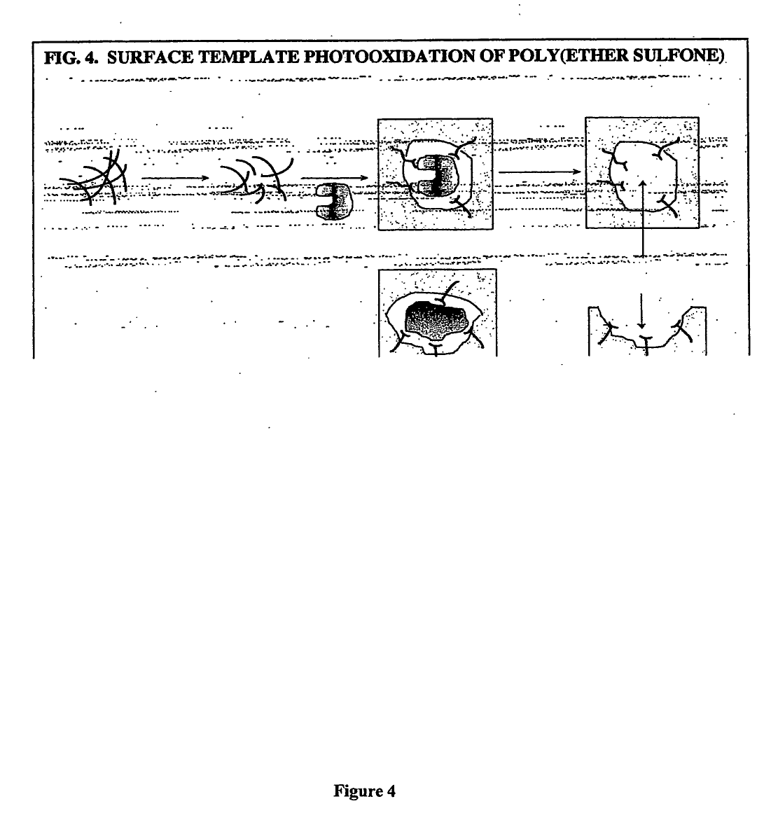

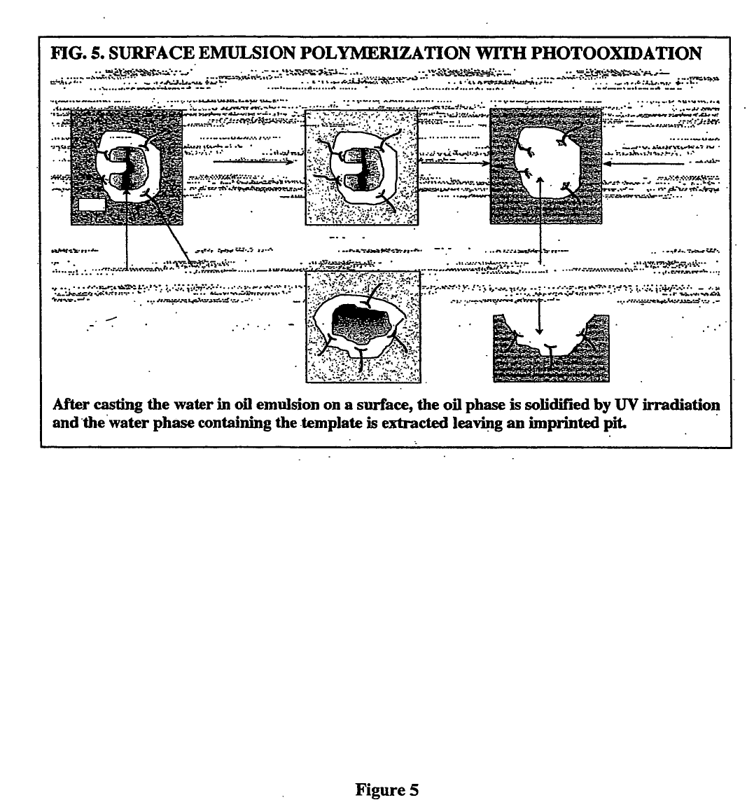

This procedure is illustrated in FIG. 4, which is a schematic drawing showing the surface template photooxidation process of the present invention, and FIG. 5, which is a schematic drawing showing the surface emulsion polymerization with photooxidation.

In particular, FIG. 4 shows a schematic representation of a novel two-dimensional method for surface imprinting recognition sites onto a photo-sensitive microporous poly(aryl sulfone) substrate (or any other substrate such as a polypropylene membrane with an added initiator) using surface template photo-oxidation. Basically, an aqueous solution is prepared containing cross-linker molecules functional groups (that have their hydrophobic tail with a double bond for later cross linking to the trunk polymer) and are interacting with the template molecules also in the solution. The substrate is then dipped into this oxygen-free solution and quickly exposed to UV photo-oxidation, an electron beam, or other high energy radiation in a oxygen-free atmosphere to form radical sites for attachment and polymerization of the cross-linked functional groups (with attached template molecules). Next, the imprinted molecules are selectively extracted using solvents or acids or microwave radiation leaving behind a surface with imprinted cavities.

As shown in FIG. 5, a schematic representation of a novel two-dimensional method for surface imprinting recognition sites onto a microporous substrate (Celgard 2500 microporous flat sheet polypropylene membrane) using water-in-oil emulsion photo-induced polymerization. Basically, a water-in-oil dispersion is prepared in which the oil contains initiator, a cross-linker, and functional groups that have their hydrophobic tail in the oil. The polar head of the functional groups are in the water droplets and interact with the template molecule that resides in the water. The oil is then “frozen′ by cross-linking the components using electromagnetic radiation (e.g., UV or photo-oxidation of an electron beam, or other high energy radiation) or a temperature increase or any other method to induce solidification and cross-linking of the oil phase. Next, the imprinted molecules are selectively extracted using solvents or acids or microwave radiation leaving behind a surface with imprinted cavities.

In the process of the present invention, either the oil phase or the water phase comprises a functional group having both a hydrophilic region and a hydrophobic region. The functional group bonds to the target molecule.

In one embodiment of the present invention, covalent bonds bind the functional group to the target molecule. Suitable functional groups of this type include a succinimide group, a boronic group, an amide group, a group which achieves an epoxy ring opening reaction, or a group which forms thiol-thiol interactions, a group which undergoes cyanogen bromide reactions, a group which undergoes periodate oxidation reactions, an oxirane group, a triazine group, a group which undergoes carbonyl imidazole activation, a group which undergoes substituted sulfone chloride activation, or a group which undergoes fluoromethyl pyridinium salt reactions.

A useful amide group can be that found on amino acids (e.g., lysines), peptides, proteins, polysaccharides, carbohydrates, hormones, or other organic molecules.

Suitable groups which achieve epoxy ring opening reactions include nucleophilic reagents such as hydroxides (OH⁻) or amines (:NH₂R) or acids (H⁺). The most widely used epoxide reaction is a condensation reaction between hydroxyl groups and epichlorohydrin or 1,4-butanediol diglycidol ether (“BDDE”).

Appropriate groups which cause thiol-thiol interactions include cysteines on a peptide or protein, thiol groups at the end of a functionalized alkanethiol, or other thiol groups under reducing conditions.

The use of groups which undergo cyanogen bromide reactions, periodate oxidation reactions, carbonyl-imidazole activation, substituted sulfone chloride activation, and fluoromethyl pyridinium salt reactions as well as oxirane groups and triazine groups are described in Klein, Affinity Membranes—Their Chemistry and Performance in Adsorptive Separation Processes pp. 27-48 (1991), which is hereby incorporated by reference in its entirety.

In another embodiment of the present invention, non-covalent bonds bind the functional group to the target molecule. Suitable functional groups of this type include functional groups which form hydrogen bonds, such as N—H bonds, O—H bonds, F—H bonds, van der Waals interactions, π-π interactions, metal-chelate interactions, salt bridges, hydrophobic interactions, or combinations thereof. Examples of these interactions between the functional group and the imprinted molecule include π-π interactions between benzene groups, metal-chelate interactions between metals such as nickel, manganese, zinc or copper with exposed histidines (e.g., Ni⁺²-(protein)-histidine (e.g., 6 histidines in series) and Cu⁺²-(protein)-histidine (e.g., 6 histidines in series)), salt bridges (Hendsch et al., Protein Sci. 3(2):211-26 (1994), which is hereby incorporated by reference in its entirety); and hydrophobic interactions. such as those between non-polar groups containing (—CHₙ, where n=1,2 or 3).

Alternatively, non-covalent binding can be achieved where the functional groups are self-assembled monolayers, poly(ethylene glycol) or ethylene glycol (which interact with metal cations), oleic acid, 2-(trifluoromethyl) acrylic acid, methacrylic acid, receptors which interact with specific groups on proteins, or combinatorial-derived strongly binding molecules to protein epitopes or specific amino acids.

Useful self-assembled monolayers include alkanethiols, silanes, amino acids, functionalized acid azide bolaamphiphiles, or other self-assembling moietics.

Suitable receptors which interact with specific groups on a protein include metals (e.g., nickel, manganese, zinc or copper) which react with histidine, groups on a carbohydrate such as lectins, ligands which bind to —SH, —OH, —NH₂, and —COOH (see 1998 Sigma Catalog, pp 1920-1921, which is hereby incorporated by reference in its entirety).

Useful combinatorial-derived strongly binding molecules on protein epitopes or specific amino acids include combinatorial organic molecule binders, or combinatorial peptide binders or combinatorial RNA binders (affibodies).

The polymerization process of the present invention can be carried out by exposing the oil phase or the polyether sulfone membrane to UV irradiation (with lamps having wavelengths of 254 or 300 nm) for a period so that the oil solidifies. In carrying out the polymerization step of the present invention, electromagnetic radiation is applied to the emulsion coated substrate. The electromagnetic radiation can be in the form of UV or photo-oxidation or electron beam or other high energy radiation or one could use a temperature-increase or any other method to induce solidification and cross-linking of the oil phase. Desirably, the emulsion is coated on the substrate as a thin film (i.e. 10 nm to 900 microns thick).

In carrying out the polymerization process of the present invention, the monomer in the oil phase can include divinylbenzene or oleic acid.

Suitable oils for the oil phase include toluene and other cross-linking agents.

In addition, the oil phase can include a polymerization initiator, a cross-linking agent, and an emulsion stabilizing agent.

Suitable polymerization initiators include azobisisobutryonitrile, benzoyl peroxide, peroxyesters, diacyl peroxides, peroxydicarbonates, monoperoxy carbonates, peroxyketals, dialkyl peroxides, and hydroperoxides.

Suitable cross-linking agents include divinylbenzene and ethylene glycol dimethacrylate.

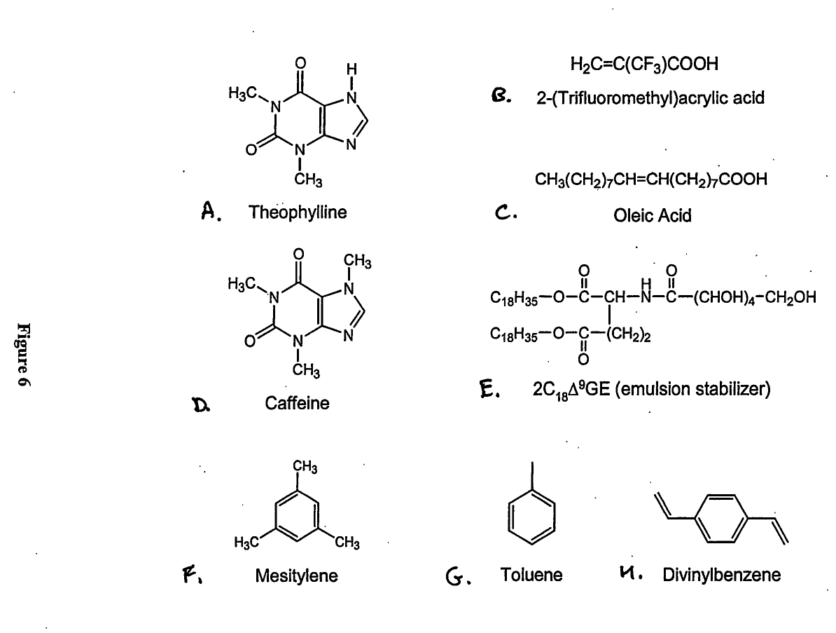

Suitable emulsion stabilizing agents include 2C¹⁸Δ⁹GE (see FIG. 6E).

The target molecule found in the water phase can be a biomolecule, including a protein, a peptide, a nucleic acid molecule (e.g., DNA or RNA), a lipid, a sugar, a glycoprotein, a glycolipid, or insulin. The target molecule also can be part of a virus, a prokaryote, or a eukaryote.

Alternatively, the target molecule can be a chemical compound. Suitable target molecules in the form of a chemical compound which can be any organic or inorganic compound.

The substrate used in the present invention can be beads, membranes, or functionalized surfaces. In any of these forms, the substrate has pores extending from one side of the substrate to another side of the substrate. Such pores permit convective flow of fluid from one side of the substrate to another side of substrate as a result of the application of a pressure gradient. The size of the substrate's pores varies as a function of the size of the target molecules but is typically 0.1 to 8.0 microns.

When a bead is utilized, the bead can be in the form of silica, agarose, polyacrylamide, or alumina.

Suitable membrane which can function as a substrate include polypropylene, polyethylene, polysulfones (e.g., polyarylsulfones), fluoro-polymers (e.g., polytetrafluoro ethylene), poly(vinylidene difluoride), celluloses (e.g., regenerated cellulose), polycarbonates, polyurethanes, polyamides, microporous glass, silver, steel, alumina, silica, or silicates.

The substrate can be a functionalized surface which is functionalized to expose organosilanes or self-assembled monolayers.

Functionalization to expose organosilanes is achieved by general organic synthesis or U.V. radiation.

Suitable self-assembled monolayers include alkanethiols on gold or acid azide bolaamphiphiles. These monolayers can have hydrophilic and hydrophobic functional groups.

The step of removing water and the target molecule from the polymerized emulsion coated substrate is carried out by contacting the polymerized emulsion coated substrate with a weak acid, a solvent, or microwave radiation. Useful weak acids are acetic acid. Suitable solvents include weak solvents for the substrate, such as N-vinyl-2-pyrrolidinone or hydroxyethyl methacrylate for poly(ether sulfone).

The process of the present invention can also include the step of sonicating the emulsion prior to polymerizing to form small water droplets. This is achieved by polymerizing to form small water droplets (e.g. by short period exposure to a typical laboratory sonicator frequency (i.e. 20 kHz from a piezoelectric crystal; Labcaire Systems Ltd For Tomorrow's Environment, 175 Kenn Road, Clevedon, North Somerset, BS21 6LH, England, UK)).

Another aspect of the present invention is directed to an article suitable for separation of a target molecule from a fluid medium. The article includes a substrate, having pores extending from one side of the substrate to another side of the substrate, and a coating over the substrate. The coating is imprinted with cavities having a conformation substantially corresponding to the target molecule. The coating comprises a functional group extending into the cavity which is suitable to bind to the target molecule.

A further aspect of the present invention is directed to a method of separating a target molecule from a fluid. This method involves providing the article of the present invention and contacting a fluid potentially containing the target molecule with the article under conditions effective to remove the target molecule from the fluid. In carrying out this aspect of the present invention, the fluid can be either a liquid or a gas. Examples of such separation procedures include recovery of: small molecules (nitrogen or oxygen) from air using hollow fiber imprinted membranes; theophylline from caffeine in water using microporous synthetic membranes; cesium ions from potassium and sodium ions in water using ethylene glycol terminated alkane chains such as BrijR 97; a specific amino acid from an aqueous solution containing other amino acids using beads or membranes as substrates; small fragments of RNA (called RNAi molecules) from a cell culture of fermentation broth; DNA fragments or organic molecules (such as hormones from a cell culture of fermentation broth), chiral compounds, transition state analogs in catalysis, and larger molecules (e.g., peptides, proteins) in which all or only part of these molecules are imprinted in the coated film or on the PES membrane.

### EXAMPLES

### Example 1

### Materials

Toluene, mesitylene (1,3,5-trimethylbenzene), oleic acid, 2-(trifluoromethyl)acrylic acid (“TFMAA”), theophylline (“THO”: 1,3-Dimethylxanthine), and caffeine (“CAF”: 1,3,7-Triinethylxanthine) were purchased from Sigma-Aldrich Co. Divinylbenzene (“DVB”, Aldrich Chemical Co.) was used after treatment with silica gel to remove an inhibitor (FIG. 6). Polypropylene (“PP”) membranes (Celgard®2500 microporous flat sheet polypropylene membrane, thickness: 25 μm, porosity: 55%, pore size: 0.05-0.2 μm wide 0.2-0.5 μm long, Celgard Inc., Charlotte, N.C.) were used as microporous substrates.

### Example 2

### Preparation of Molecularly Imprinted Polymer

0.56 g(2.0×10⁻³ mol) of oleic acid, 0.28 g(2.0×10⁻³ mol) of 2-(trifluoromethyl)acrylic acid (“TFMAA”), and 0.23 g (3.0×10⁻⁴ mol) of N-ribitol L-glutamic acid dioleyl diester (2C₁₈Δ⁹GE, emulsion stabilizer¹⁴) were dissolved in 60 ml of toluene/DVB (1:2 (v/v)), which was mixed with 30 ml aqueous solution containing 0.14 g (8×10⁻⁴ mol) of theophylline. Although methacrylic acid (“MAA”, pKₐ=4.6) and TFMAA (pKₐ=2.3) have been used as functional monomers for various template molecules, TFMAA was chosen since it was more acidic and could increase hydrogen-bonding with the template (Mosbach et al., J. Am. Chem. Soc. 123:12420-12421 (2001); Matsui et al., Anal Chem. 72:3286 (2000); and Yilmaz et al., Angew. Chem. Int. Ed. 39:2115-2118 (2000), which are hereby incorporated by reference in its entirety). Using only oleic acid (without TFMAA) as a functional monomer, selectivity for THO over CAF was hardly noticeable. The mixture was sonicated for 5 min to give a water-in-oil (w/o) emulsion. After adding 0.36 g of 2,2′-azobisisobutyronitrile (“AIBN”), the mixture (water-in-oil emulsion) was sonicated for 3 min. After the mixture was kept at room temperature for 5 min, 24 ml of upper organic layer was removed to concentrate the emulsion.

The polypropylene membrane (5 cm×8.8 cm) was dipped into the emulsion for 5-10 sec. The membrane was fixed to the polypropylene holder and placed in the quartz vessel. After a 5 min nitrogen purge, the polypropylene membrane was modified using a UV-induced polymerization procedure. A Rayonet photochemical chamber reactor system (Model RPR-100, Southern New England, Ultraviolet Co., Branford, Conn.) with sixteen 300 nm UV lamps (˜15% of the energy was at <280 nm) was used. This was the same UV reactor used previously by applicants (Pieracci et al., Chem. Mater. 12:2123-2133 (2000) and Koehler et al., Langmuir 16:10419-10427 (2000), which are hereby incorporated by reference in their entirety). After UV irradiation for 10 min, the membrane was washed with 5 wt % aqueous acetic acid (1 hour, 3 times) at room temperature to remove the absorbed THO (Wang et al., Langmuir 12:4850-4856 (1996), which is hereby incorporated by reference in their entirety). The imprinted membrane was dried under vacuum. The nonimprinted polypropylene membrane was prepared using the same procedure as THO-imprinted one in the absence of theophylline.

### Example 3

### Characterization

Attenuated total reflection Fourier transform infrared spectroscopy (“ATR/FT-IR”) (Magna-IR 550 Series II, Nicolet Instruments, Madison, Wis.) was used to confirm polymerization and to measure the degree of grafting onto the polypropylene membrane under UV irradiation. Using an incident angle of 45°, the penetration of IR sample depth was approximately 0.1-1.0 μm (Nicolet User's Manual for Infrared Spectrometer, Model# 0012-490(T) Nicolet Magna-IR, Thermo Nicolet Corp, Madison, Wis., which is hereby incorporated by reference in its entirety). Each spectrum was recorded at aresolution of 4.0 cm⁻¹. The absorbance peak heights at 1376, and 1458 cm⁻¹ were due to C—H bending of polypropylene membrane (Wang et al., J. Chem. Tech. Biotech. 70:355-362 (1997) and Pretsch et al., Table of Spectral Data for Structure Determination of Organic Compounds 2^{nd} ed.; Fresenius, W., Huber, J. K. F., Pungor, E., Rechnitz, G. A., Simon, W., West, Th. S., Eds.; Springer-Verlag: Berlin Heidelerg (1989), which are hereby incorporated by reference in their entirety). The degree of grafting is defined as
N DG=[I₁₆₀₀/I₁₃₇₆]ₜ−[I₁₆₀₀/I₁₃₇₆]_{unmodified PP} (1)
where [I₁₆₀₀/I₁₃₇₆]ₜ and [I₁₆₀₀/I₁₃₇₆]_{unmodified PP} are the ratio of the peak height of the benzene carbon-carbon double (C═C) bond at 1600 cm⁻¹ to that of C—H bending of the polypropylene membrane at 1376 cm⁻¹ at the irradiation time (t) and initially for the unmodified polypropylene membrane, respectively.

Sessile contact angles, θ, of water drops on unmodified and modified polypropylene membrane surfaces were measured using a video camera (SIT66, Dage-MTI Inc., Michigan City, Ill.) connected to a video screen and tape recorder (Pieracci et al., Chem. Mater. 12:2123-2133 (2000) and Koehler et al., Langmuir 16:10419-10427 (2000), which are hereby incorporated by reference in their entirety). A protocol for correcting for capillary forces and roughness has been developed (Taniguchi et al., Langmuir 17:4312 (2001) and Taniguchi et al., Langmuir 18:6465 (2002), which are hereby incorporated by reference in their entirety). Unfortunately the standard captive bubble in water method could not be used here because of the solubility of THO and CAF in water. Hence, the standard sessile water drop method was used with many measurements (at least 10 for each sample) and very fast after the drop had been deposited onto the substrate (within 20-30 s) in order to minimize capillary effects. The standard error in θ was approximately ±2 °.

Topographical AFM images of unmodified and imprinted polypropylene membranes were made in contact mode using silicon nitride cantilevers (TM Microscopes, Sunnyvale, Calif.) with an atomic force microscope (AFM, Auto Probe PC, Park Scientific Instruments) and surface analysis and data acquisition software (Pro Scan Version 1.5, Park Scientific Instruments). Taniguchi et al. (Taniguchi et al., Langmuir 17:4312 (2001) and Taniguchi et al., Langmuir 18:6465 (2002), which are hereby incorporated by reference in their entirey) have used AFM to estimate the roughness of a surface (mean vertical, δ_{V}, and horizontal, δ_{H}, length scales, and mean roughness angle, α) and correct the measured contact angles to obtain an intrinsic (or corrected) contact angle for a rough or porous surface. More than 300 measurements of the depth (mean vertical distance of top of peak to bottom of groove) and the width (mean horizontal peak to peak) for each membrane surface were obtained. Other common measures of roughness that will be used include the average roughness,

$${R}_{ave} , ( = {\sum }_{n = 1}^{N} \frac{\vert {Z}_{n} - \overline{Z} \vert}{N} , where \overline{Z} = mean height )$$

where Z̅=mean height) and the roughness factory, γ,(ratio of the actual surface area to the projected surface area).

¹H NMR spectra were obtained using a Varian 500 MHz spectrometer (Varian Associates Inc.) at room temperature. Mesitylene (1,3,5-trimethylbenzene) (b.p. 162-164° C./760 mmHg) was used as an internal standard, because tetramethylsilane (b.p. 26-28° C.) was susceptible to evaporation during the sonication before the NMR measurements (FIG. 6).

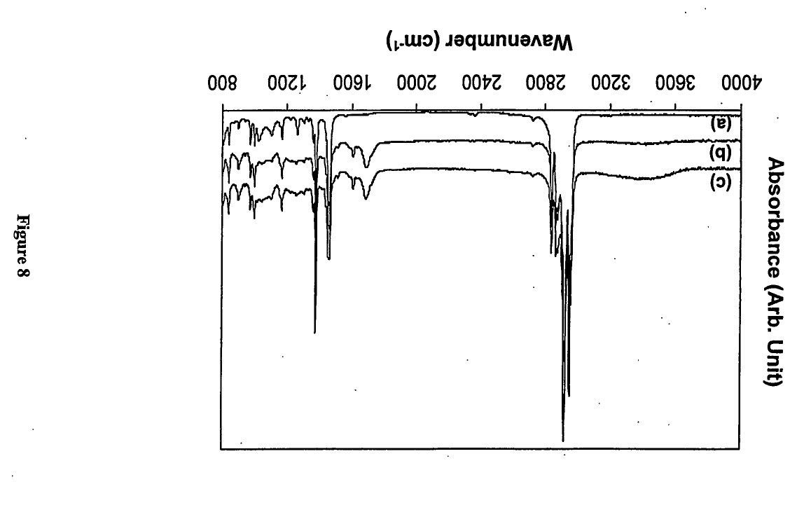

ATR/FT-IR confirmed that photochemical polymerization occurred on the polypropylene membrane surface (FIG. 8). The most significant change in the spectra of the imprinted polypropylene membranes was the appearance of absorption bands in the range 1450-1750 cm⁻¹, signifying the carbonyl stretch of oleic acid, TFMAA, N-ribitol L-glutamic acid dioleyl diester (Uezu et al., Macromolecules 30:3888-3891 (1997); Yoshida et al., Macromolecules 32:1237-1243 (1999); and Uezu et al., J. Chem. Eng. Jpn. 27:436-438 (1994), which are hereby incorporated by reference in their entirety) (2C₁₈Δ⁹GE) and THO, and the C═C stretch of the phenyl group of divinylbenzene (FIG. 6). An intermediate degree of grafting (DG=0.069) for the 300 nm lamps was achieved even at a short irradiation time of 10 min (exposure energy=39 J/cm²), which is very short compared to that for thermal polymerization (Uezu et al., Macromolecules 30:3888-3891 (1997); Yoshida et al., Macromolecules 32:1237-1243 (1999); Uezu et al., J. Chem. Eng. Jpn. 27:436-438 (1994); Yilmaz et al., Angew. Chem. Int. Ed. 39:2115-2118 (2000), which are hereby incorporated by reference in their entirety) (DG versus time of irradiation).

Corrected sessile contact angle measurements gave useful supporting information on the surface modification. As expected, the unmodified polypropylene membrane (102±2°) was more hydrophobic than the THO-imprinted (sans THO template) (88±2°) and the imprinted with THO bound (78±2°; after dipping the THO-imprinted membrane into 1 mM THO solution for 1 day) polypropylene membrane (Table 2). Modifying the polypropylene membrane made the surface more hydrophilic. The contact angle of the imprinted polypropylene membrane decreased by about 14° from that of the original untreated polypropylene membrane. The contact angle of the THO-imprinted membrane, after binding THO from solution, decreased by about another 10°. These changes in the values of the contact angles are clearly significant (Pieracci et al., Chem. Mater. 12:2123-2133 (2000); Koehler et al., Langmuir 16:10419-10427 (2000); Pieracci et al., Chem. Mater. 14:256 (2002); and Kang et al., Langmuir 17:4352 (2001), which are hereby incorporated by reference in their entirety). Furthermore, after dipping the imprinted membrane into a 1.0 mM THO solution, abroad absorption band around 3600-3000 cm⁻¹ appeared in IR spectra, which is likely due to formation of hydrogen bonds (FIG. 8) between the template, functional monomers and residual water on the dried membrane (Wang et al., J. Chem. Tech. Biotech. 70:355-362 (1997) and Pretsch et al., Table of Spectral Data for Structure Determination of Organic Compounds 2^{nd} ed.; Fresenius, W., Huber, J. K. F., Pungor, E., Rechnitz, G. A., Simon, W., West, Th. S., Eds.; Springer-Verlag: Berlin Heidelerg (1989), which are hereby incorporated by reference in their entirety). These changes in contact angle and IR spectra indirectly confirm the formation of THO-cavities onto the coated polypropylene membrane and the binding of THO to this imprinted membrane.

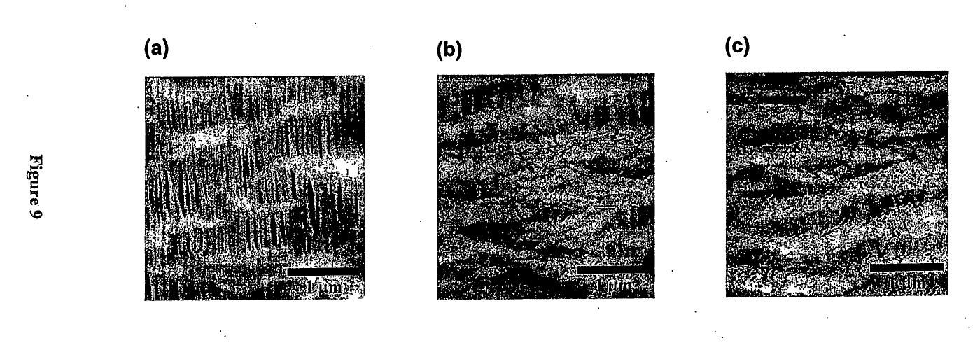

With respect to the AFM images of the same three membranes, the unmodified, the THO-imprinted sans THO, and the imprinted with bound THO, several differences can be seen in FIG. 9. The topographical AFM image of the unmodified polypropylene membrane (FIG. 9A) is similar to the scanning electron micrograph image available from Celgard Inc. Also, the unmodified membrane has strands (FIG. 9A) which are covered with photo-polymerized coating (FIG. 9B): THO-imprinted membrane sans THO). On binding of the THO template, the identity of the strands have disappeared (FIG. 9C), although small pores are still clearly noticeable. Referring to Table 2, two roughness parameters, γ and α (=tan⁻¹δ_{V}/δ_{H}) increased in value for the three membranes listed above. For Rₐᵥₑ, there was no significant difference between the unmodified and the THO-imprinted (sans THO) membranes. On binding THO to the imprinted membrane, Rₐᵥₑ increased significantly. Clearly, coating the membrane with the photo-polymerized imprinted surface and binding the THO template result in a modest and significant increase in surface roughness, respectively. The presence or absence of the template in the affinity cavity makes a difference to the condition of the coating layer.

To evaluate competitive binding between THO and CAF, THO-imprinted and nonimprinted polypropylene membranes (5 cm×8.8 cm), were dipped into various concentrations of mixtures of THO and CAF (1:1) in 4 ml of water:ethanol (1:1 (v/v)) solution (theophylline could dissolve well in 50:50 (v/v) aqueous ethanol) for 1 day. The membranes were removed and the remaining solution in the test tube was evaporated and dried under vacuum for 3 hours. An abundance of chloroform-d was added to the test tube and the sample tube was sealed with Parafiln (Fischer Scientific, Suwanee, Georgia) and allowed to sonicate for more than 4 hours. Mesitylene in chloroform-d as an internal standard (with typical proton peaks at 2.26 and 6.78 ppm) was added to the sample tube and sonicated for 30 min, before NMR measurements. The separation factor for THO over CAF is defined as (Steinke et al., Macromolecules 29:407-415 (1996), which is hereby incorporated by reference in its entirety)

$$α = \frac{{K}_{THO}}{{K}_{CAF}} = \frac{\{ {[ THO ]}_{s}^{0} - [ {THO}_{s}^{t} ) / {[ THO ]}_{s}^{t} \}}{\{ {[ CAF ]}_{s}^{0} - [ {CAF}_{s}^{t} ) / {[ CAF ]}_{s}^{t} \}} \qquad ( 2 )$$

where K_{THO} and K_{CAF} are the equilibrium distribution constants for THO and CAF between the coated polypropylene membrane and the solution. [THO]_{S}⁰ and [CAF]ₛ⁰ are the initial concentrations of THO and CAF in the solution mixture. [THO]ₛ^{t} and [CAF]ₛ^{t} represent the concentrations of THO and CAF in the remaining solution mixture after time t, respectively. These concentrations were evaluated from the changes in proton peak areas at 3.64 and 3.44 ppm for THO, 3.59 and 3.41 ppm for CAF, and 6.78 and 2.26 ppm for the internal standard, mesitylene.

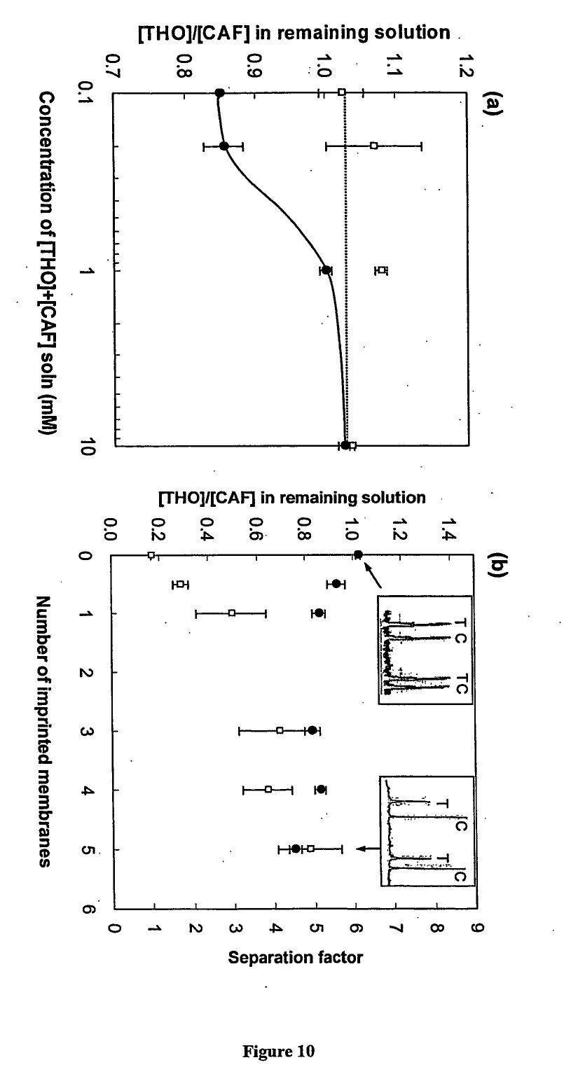

As shown in FIG. 10A, which was constructed from the NMR data, the THO-imprinted membrane exhibited selectivity for THO over CAF. Unlike the nonimprinted membrane, selectivity of the imprinted membrane for THO over CAF rose with decreasing concentration of the mixture. For example, the ratio of [THO] over [CAF] in remaining solution after dipping a sheet of imprinted membrane (5 cm×8.8 cm) into THO and CAF mixture solution was about 0.85 at the lower concentration of 0.2 mM compared with 1.02 (no significant selectivity) at the high concentration of 10 mM. In order to check whether the number of molecular recognition sites was limiting at the high concentrations, additional imprinted polypropylene membranes were added to a solution containing 0.2 mM THO and CAF (1:1) in a water:ethanol (1:1 (v/v) solution). FIG. 10B shows the relationship between separation factor and the number of imprinted polypropylene membranes (proportional to the number of THO-recognition sites). As expected, selective affinity for THO increased with the number of THO-recognition sites and a high separation factor of 4.9±0.8 was obtained when 5 sheets of imprinted membrane was dipped into the solution. The NMR data confirmed the formation of THO-recognition sites on the imprinted membrane and their selective affinity for THO over CAF was consistent with the changes in contact angle and IR spectra. Repeated measurements at room temperature with the same THO-imprinted membrane after six months exhibited the same high value of the selectivity (˜5) for THO over CAF.

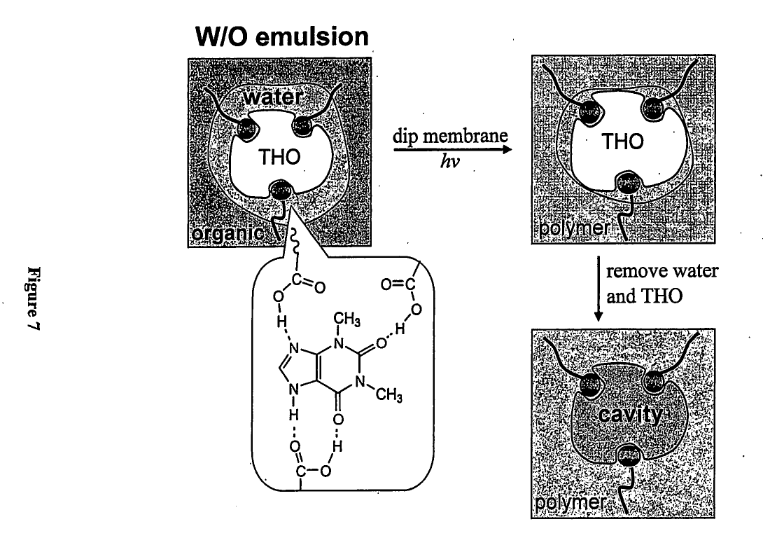

With respect to the preparation of discriminate surface molecular recognition sites on a microporous substrate, the two-step procedure described in FIG. 7 illustrates the proposed mechanism. The fact that omitting the functional monomers (TFMAA and/or oleic acid) from the mixture results in zero selectivity between theophylline (THO) and caffeine (CAF) suggests their critical importance. The contact angle measurements also confirm that the polypropylene surface has been modified. The roughness-corrected contact angles for the unmodified, the imprinted sans THO, and imprinted with bound THO membranes were 102±2°, 88±2°, and 78±2°, respectively (Table 2).

TABLE 2
Roughness-Corrected Sessile Contact Angle Measurements of Water
Drops on the Unmodified, the Tho-Imprinted (sans THO Template),
and the Imprinted Membrane With Bound Template.

| Membrane^{a} | Rₐᵥₑ^{b} | γ^{c} | α^{d} | θ_{M}^{e} | θ^{f} |
|---|---|---|---|---|---|
| Unmodified^{g} | 232 ± 40 | 1.5 ± 0.1 | 13.3 ± 1.7 | 115 ± 2 | 102 ± 2 |
| Imprinted^{h} | 220 ± 20 | 1.6 ± 0.2 | 17.6 ± 1.2 | 106 ± 2 | 88 ± 2 |
| Imprinted-THOⁱ | 330 ± 50 | 2.7 ± 0.2 | 29.9 ± 2.1 | 108 ± 2 | 78 ± 2 |

^{a}The substrate was a microporous polypropylene membrane
(Celgard ® 2500).
${}^{b} The average roughness , {R}_{ave} = {\sum }_{n = 1}^{N} \frac{\vert {Z}_{n} - \overline{Z} \vert}{N} , where \overline{Z} = mean height .$
^{c}The roughness factor, γ (= ratio of the actual surface area to the projected
surface area).
^{d}Mean roughness angle, α [= tan⁻¹(δ_{V}/δ_{H}), where δ_{V} and δ_{H} are the mean
vertical and horizontal characteristic lengths of the rough surface as
measured by AFM].
^{e}The measured sessile contact angle, θ_{M}. Contact angles were measured at
least 10 times for each sample.
^{f}The corrected sessile contact angle, θ (= θ_{M} − α)
^{g}Unmodified means original polypropylene membrane without treatment.
^{h}THO-imprinted membrane from which the THO template has been
removed (extracted).
ⁱImprinted-THO means a THO-imprinted membrane that has been exposed
to a 1 mM THO solution for 1 day.

Clearly, the difference between these values of θ are significant and indicate that the photo-polymerization imprinted coating is hydrophilic and that binding the template into the affinity cavities increases the hydrophilicity of the surface even more. Goto and coworkers have optimized a similar process for imprinting metals (Uezu et al., Macromolecules 30:3888-3891 (1997); Yoshida et al., Macromolecules 32:1237-1243 (1999); and Uezu et al., J. Chem. Eng. Jpn. 27:436-438 (1994), which are hereby incorporated by reference in its entirety).

Since it has been demonstrated that THO distributes favorably into the water as opposed to the oil phase, it is thus likely that the THO template interacted with the functional monomers as described in FIG. 7.

In spite of the fact that THO is a stronger base than CA (pKₐ of 5.2 and 3.6, respectively, it was demonstrated to have selectivity with nonimprinted polypropylene membranes. Clearly, imprinting was needed to effect selectivity and the difference in pKₐ values did not have a major effect.

With regard to the transfer of the water drops (containing template) in oil to the substrate, a color change from white (un-reacted) to yellow (coated) was observed on both faces of the imprinted polypropylene membrane, suggesting that they were coated with the polymerized imprinted material. It is estimated from observation and the literature that the water drops were in the size range from 0.1-1 μm (Gilbert R.G. In Emulsion Polymerization; Ottewill, R. H.; Rowell, R. L., Eds.; Academic Press Ind.: San Diego (1995); Leal-Calderon et al., Langmuir 13:7008 (1997); Leal-Calderon et al., Langmuir 12:872 (1996); and Williams et al., Langmuir 6:437 (1990), which are hereby incorporated by reference in their entirety). Since the pores (not contiguous and produced by stretching the bulk material) of the polypropylene microporous membrane had a size range from 0.05-0.2 μm in width and 0.2-0.5 μm in length (see FIG. 9A), it was possible for the smaller water drops to enter the pores. The rest of the droplets likely coated the outside faces of the membrane (FIG. 9B). Clearly, larger pore-size membranes will be needed to increase the number of the imprinted cavities and the capacity of the membranes.

Other issues are the importance of fixing the coating to the support and the stability of the composite imprinted membranes. A cross-linked coating on a porous membrane is the process used for the production of some commercial membranes (Durapore line, Millipore Corp. Bedford, Mass.), a durable and popular membrane. Their coating (cross-linked poly(acrylate)) is not covalently linked to the microporous poly(vinylidene fluoride) substrate (U.S. Pat. No. 4,618,533 to Steuke), which is hereby incorporated by reference in its entirety). This example illustrates that, for a stable membrane, all one needs is a good stable cross-linked coating, which are believed to have been the imprinted membranes. Direct covalent bonding to the substrate is not required. The imprinted membranes were stable and robust and could be handled without loss of the coating. Also, as mentioned above, the imprinted membranes have now been re-tested after a six-month period and give virtually the same selectivities as originally reported.

A novel, simple and inexpensive two-dimensional surface molecular imprinting method using water-in-oil emulsion polymerization on a microporous polypropylene substrate was developed. To test the method, theophylline was imprinted on a synthetic polypropylene membrane and demonstrated a preferential selectivity of 4.9±0.8 for theophylline over caffeine in aqueous medium. Doing this in aqueous medium rather than organic solvents may offer the possibility of imprinting larger molecules of biological interest. Further work with biological molecules and convective flow to improve mass transfer is being pursued. Moreover, since the surface molecular imprinting method presented here uses a relatively simple technique withflexible porous membranes and overcomes several major limitations associated with previous three- and two-dimensional imprinting methods, new opportunities for applications and scale-up of molecular imprinting are now possible.

Although preferred embodiments have been depicted and described in detail herein, it will be apparent to those skilled in the relevant art that various modifications, additions, substitutions and the like can be made without departing from the spirit of the invention and these are, therefore, considered to be within the scope of the invention as defined in the claims which follow.

What is claimed:

1. A method of producing a substrate suitable for separation of a target molecule from a fluid medium, said method comprising:
providing an emulsion comprising a water phase in an oil phase, wherein the oil phase comprises a polymerizable monomer and the water phase comprises the target molecule;
coating a substrate, having pores extending from one side of the substrate to another side of the substrate, with the emulsion;
polymerizing the monomer in the emulsion coated substrate; and
removing water and the target molecule from the polymerized, emulsion coated substrate, whereby the substrate is imprinted with the target molecule and, therefore, is suitable for separation of the target molecule from a fluid medium.

2. The method of claim 1, wherein either the oil phase or the water phase comprises a functional group having both a hydrophilic region and a hydrophobic region, wherein the functional group bonds to the target molecule.

3. The method of claim 2, wherein covalent bonds bond the functional group to the target molecule.

4. The method of claim 3, wherein the functional group is selected from the group consisting of a succinimide group, a boronic acid, an amide group, a group which achieves an epoxy ring opening reaction, a group which forms thiol-thiol interactions, a group which undergoes cyanogen bromide reactions, a group which undergoes periodate oxidation reactions, an oxirane group, a triazine group, a group which undergoes carbonyl imidazole activation, a group which undergoes substituted sulfone chloride activation, and a group which undergoes fluoromethyl pyridinium salt reactions.

5. The method of claim 2, wherein non-covalent bonds bond the functional group to the target molecule.

6. The method of claim 5, wherein the functional group forms hydrogen bonds selected from the group consisting of N—H bonds, O—H bonds, F—H bonds, van der Waals interactions, π-π interactions, metal-chelate interactions, salt bridges, hydrophobic interactions, and combinations thereof.

7. The method of claim 5, wherein the functional group is selected from the group consisting of alkanethiols, silanes, amino acids, functionalized acid azide bolaamphiphiles, poly(ethylene glycol) or ethylene glycol, oleic acid, 2-(trifluoromethyl) acrylic acid, methacrylic acid, receptors which interact with specific groups on proteins, and combinatorial-derived strongly binding molecules to protein epitopes or specific amino acids.

8. The method of claim 1, wherein the oil phase further comprises a polymerization initiator.

9. The method of claim 1, wherein the oil phase further comprises a cross-lining agent.

10. The method of claim 1, wherein the oil phase further comprises an emulsion stabilizing agent.

11. The method of claim 1, wherein the substrate is selected from the group consisting of beads, membranes, and functionalized surfaces.

12. The method of claim 11, wherein the substrate is a bead formed from a material selected from the group consisting of silica, agarose, polyacrylamide, and alumina.

13. The method of claim 11, wherein the substrate is a membrane formed from a material selected from the group consisting of polypropylene, polyethylene, polysulfones, fluoro-polymers, poly(vinylidene difluoride), celluloses, polycarbonate, polyurethane, polyamides, microporous glass, silver, steel, alumina, silica, and silicates.

14. The method of claim 11, wherein the substrate is a functionalized surface, wherein the surface is functionalized to expose organosilanes or self-assembled monolayers.

15. The method of claim 1, wherein said polymerizing is carried out by applying electromagnetic radiation to the emulsion coated substrate.

16. The method of claim 1, wherein the emulsion is coated on the substrate as a thin film.

17. The method of claim 1 further comprising:
sonicating the emulsion prior to said polymerizing to form small water droplets.

18. The method of claim 1, wherein the target molecule is a molecule of biological orgin.

19. The method of claim 18, wherein the target molecule is a protein, a peptide, a nucleic acid molecule, a sugar, a lipid, a glycoprotein, a glycolipid, or insulin.

20. The method of claim 19, wherein the target molecule is part of a virus, a prokaryote, or a eukaryote.

21. The method of claim 1, wherein the target molecule is a chemical compound.

22. The method of claim 1, wherein said removing is carried out by contacting the polymerized emulsion coated substrate with a weak acid, a solvent, or microwave radiation.

23. An article suitable for separation of a target molecule from a fluid medium comprising:
a substrate, having pores extending from one side of the substrate to another side of the substrate, and
a coating over the substrate imprinted with cavities having a conformation substantially corresponding to the target molecule, wherein the coating comprises a functional group extending into the cavity and suitable to bind to the target molecule.

24. The article of claim 23, wherein covalent bonds bond the functional group to the target molecule.

25. The article of claim 24, wherein the functional group is selected from the group consisting of a succinimide group, a boronic acid, an amide group, a group which achieves an epoxy ring opening reaction, a group which forms thiol-thiol interactions, a group which undergoes cyanogen bromide reactions, a group which undergoes periodate oxidation reactions, an oxirane group a triazine group, a group which undergoes carbonyl imidazole activation, a group which undergoes substituted sulfone chloride activation, and a group which undergoes fluoromethyl pyridinium salt reactions.

26. The article of claim 23, wherein non-covalent bonds bond the functional group to the target molecule.

27. The article of claim 26, wherein the functional group forms hydrogen bonds selected from the group consisting of N—H bonds, O—H bonds, F—H bonds, van der Waals interactions, π-π interactions, metal-chelate interactions, salt bridges, hydrophobic interactions, and combinations thereof.

28. The article of claim 26, wherein the functional group is selected from the group consisting of alkanethiols, silanes, amino acids, functionalized acid azide bolaamphiphiles, poly(ethylene glycol) or ethylene glycol, oleic acid, 2-(trifluoromethyl) acrylic acid, methacrylic acid, receptors which interact with specific groups on proteins, and combinatorial-derived strongly binding molecules to protein epitopes or specific amino acids.

29. The article of claim 23, wherein the substrate is selected from the group consisting of beads, membranes, and functionalized surfaces.

30. The article of claim 23, wherein the substrate is a bead is formed from a material selected from the group consisting of silica, agarose, polyacrylamide, and alumina.

31. The article of claim 23, wherein the substrate is a membrane selected from the group consisting of polypropylene, polyethylene, polysulfones, fluoro-polymers, poly(vinylidene difluoride), celluloses, polycarbonate, polyurethane, polyamides, microporous glass, silver, steel, alumina, silica, and silicates.

32. The article of claim 23, wherein the substrate is a functionalized surface, wherein the surface is functionalized to expose organosilanes or self-assembled monolayers.

33. The article of claim 23, wherein the polymer is coated on the substrate as a thin film.

34. The article of claim 23, wherein the target molecule is a molecule of biological origin.

35. The article of claim 34, wherein the target molecule is a protein, peptide, a nucleic acid molecule, a lipid, a glycoprotein, a glycolipid, a sugar, or insulin.

36. The article of claim 34, wherein the target molecule is part of a virus, a prokaryote, or a eukaryote.

37. The article of claim 23, wherein the target molecule is a chemical compound.

38. A method of separating a target molecule from a fluid comprising:
providing the article of claim 23 and
contacting a fluid potentially containing the target molecule with the article under conditions effective to remove the target molecule from the fluid.

39. The method of claim 38, wherein the fluid is a liquid.

40. The method of claim 38, wherein the fluid is a gas.

41. The method of claim 38, wherein covalent bonds bond the functional group to the target molecule.

42. The method of claim 41, wherein the functional group is selected from the group consisting of a succinimide group, a boronic acid, an amide group, a group which achieves an epoxy ring opening reaction, a group which forms thiol-thiol interactions, a group which undergoes cyanogen bromide reactions, a group which undergoes periodate oxidation reactions, an oxirane group, a triazine group, a group which undergoes carbonyl imidazole activation, a group which undergoes substituted sulfone chloride activation, and a group which undergoes fluoromethyl pyridinium salt reactions.

43. The method of claim 38, wherein non-covalent bonds bond the functional group to the target molecule.

44. The method of claim 43, wherein the functional group forms hydrogen bonds selected from the group consisting of N—H bonds, O—H bonds, F—H bonds, van der Waals interactions, π-π interactions, metal-chelate interactions, salt bridges, hydrophobic interactions, and combinations thereof.

45. The method of claim 43, wherein the functional group is selected from the group consisting of alkanethiols, silanes, amino acids, functionalized acid azide bolaamphiphiles, poly(ethylene glycol) or ethylene glycol, oleic acid, 2-(trifluoromethyl) acrylic acid, methacrylic acid, receptors which interact with specific groups on proteins, and combinatorial-derived strongly binding molecules to protein epitopes or specific amino acids.

46. The method of claim 38, wherein the substrate is selected from the group consisting of beads, membranes, and functionalized surfaces.

47. The method of claim 46, wherein the substrate is a bead formed from a material selected from the group consisting of silica, agarose, polyacrylamide, and alumina.

48. The method of claim 46, wherein the substrate is a membrane formed from a material selected from the group consisting of polypropylene, polyethylene, polysulfones, fluoro-polymers, poly(vinylidene difluoride), celluloses, polycarbonate, polyurethane, polyamides, microporous glass, silver, steel, alumina, silica, and silicates.

49. The method of claim 46, wherein the substrate is a functionalized surface, wherein the surface is functionalized to expose organosilanes or self-assembled monolayers.

50. The method of claim 38, wherein the polymer is coated on the substrate as a thin film.

51. The method of claim 38, wherein the target molecule is a biomolecule.

52. The method of claim 51, wherein the target molecule is a protein, a peptide, a nucleic acid molecule, a sugar, a lipid, a glycoprotein, a glycolipid, or insulin.

53. The method of claim 51, wherein the target molecule is part of a virus, a prokaryote, or a eukaryote.

54. The molecule of claim 38, wherein the target molecule is a chemical compound.
